(19) United States
(12) Patent Application Publication
(10) Pub. No.: US 2013/0259071 A1
(43) Pub. Date: Oct. 3, 2013

(54) BROADBAND OPTICAL ACCUMULATOR AND TUNABLE LASER USING A SUPERCONTINUUM CAVITY

(71) Applicant: Sébastien Blais-Ouellette, Laval (CA)

(72) Inventor: Sébastien Blais-Ouellette, Laval (CA)

(73) Assignee: PHOTON ETC INC., Montreal, QC (CA)

(21) Appl. No.: 13/820,315

(22) PCT Filed: Aug. 29, 2011
(86) PCT No.: PCT/CA2011/050525

§ 371 Date: Jun. 19, 2013

Related U.S. Application Data
(60) Provisional application No. 61/379,515, filed on Sep. 2, 2010.

(51) Int. Cl. H01S 3/1055

(52) U.S. Cl. CPC H01S 3/1055
USPC 372/20

(57) ABSTRACT

A broadband optical accumulator and tunable narrowband optical source use a microstructured optical fiber into which optical energy is coupled at a first wavelength. The input optical energy is spectrally broadened as it propagates through the fiber, and the output signal is directed to a wavelength separator such as a Bragg grating. A narrowband portion of the output signal is redirected by the grating, while the remainder is reinjected into the fiber. Adjustment of the output wavelength band may be accomplished by changing the incidence angle of the output signal by pivoting the grating. The grating may be located in a housing and surrounded by index matching fluid, and the narrowband portion of the output signal isolated by the grating may be redirected to an output location by a reflector that moves with pivoting of the grating.

### FIELD OF THE INVENTION

This invention relates generally to optical signal sources and, more specifically, to tunable optical signal sources.

### BACKGROUND OF THE INVENTION

Tunable optical sources, such as tunable lasers for which a center wavelength of the source output can be adjusted ever a continuous wavelength range, have a great many uses in a variety of different disciplines. However, historically, such sources have suffered from either a limited tuning range or a relatively low efficiency, that is, the optical energy output at the desired wavelength is small compared to the amount of energy used to generate it. This results in a great many existing tunable sources having an output power that is too low for certain applications, or not being cost effective to operate.

### SUMMARY OF THE INVENTION

In accordance with the present invention, a broadband optical accumulator is provided that makes use of a supers cavity. A microstructured fiber is configured such that an optical signal present in the fiber propagates repeatedly therein. A narrowband optical source is then used to generate optical energy in a first narrow wavelength band, and an injection apparatus couples the narrow wavelength band optical energy into a first end of the fiber, the narrowband optical energy undergoing spectral broadening as it propagates within the fiber cavity.

In an exemplary embodiment, the source has a pulsed output, although continuous wave sources may be used as well. The spectral broadening of the narrowband optical energy as it propagates in the fiber is such that an output signal exiting a second end of the fiber has a broadened spectral characteristic. At least a predetermined portion of the output signal is then coupled back into the first end of the fiber.

In an exemplary embodiment, the injection apparatus is a wavelength dependent element, such as a volume Bragg grating, located in an optical path of the optical energy exiting the second end of the fiber. The wavelength dependent element redirects the optical energy from the optical source toward the first end of the fiber such that it is coupled into the first end of the fiber together with optical energy exiting the second end of the fiber.

Using the basic structure of the broadband optical accumulator, a narrowband optical signal generator embodiment may be created. The microstructured fiber and narrowband optical source are provided as described above such that an output signal exits the second end of the optical fiber that has a broadened spectral characteristic. In this embodiment, however, the output signal is received by a wavelength separator as it exits the fiber, and a narrowband portion of the output signal is redirected by the wavelength separator to an output location. A collimator may also be provided that collimates the light exiting the fiber prior to it reaching the wavelength separator. The remainder of the output signal, that is the portion that is not redirected, is allowed to be coupled back into the fiber. Notably, the wavelength separator has a center filter wavelength that is significantly different from a center wavelength of the first narrow wavelength band of the narrowband optical source. Thus, the optical energy output by the system is in a different narrow wavelength band than that input to the system.

In an exemplary embodiment of the invention, the wavelength separator comprises a volume Bragg grating that separates the narrowband portion of the output signal from the remainder of the output signal. In this embodiment, the narrow wavelength band may be tuned by changing the angle at which the output signal is incident on the grating. That is, the angle of incidence between the output signal and the grating may be adjusted to adjust a center filter wavelength of the narrowband portion isolated from the output signal. One way to change this angle is to pivot the grating about a point substantially at the center of the grating. The grating may also be pivoted about a point significantly offset from the center of the grating. In one embodiment, the grating is located on a rotation table along with an output component, such as a mirror, that receives the narrowband portion from the grating. In this case, the component may be located on the rotation table such that, when the table is rotated, the output component moves relative to the grating so as to receive the narrowband portion for each of a plurality of different grating positions. In another variation, the narrow wavelength band filter may be surrounded by a refractive index matching material that minimizes refraction of the remainder of the output signal. A housing may be used to surround the filter and the index matching material so as to contain them.

### BRIEF DESCRIPTION OF THE DRAWINGS

FIG. 1 is a schematic plan view of a broadband optical accumulator according the present invention.

FIG. 2 is a schematic plan view of a tunable narrowband optical signal generator that makes use of the broadband optical accumulator of FIG. 1.

FIG. 3 is an isolated view of the output section of an optical signal generator such as that of FIG. 2, showing the use of an index matching liquid surrounding a Bragg grating used for tuning the output.

FIG. 4 is an isolated view like that of FIG. 3 showing a movable output reflector used to redirect the narrowband optical output from an output Bragg grating that pivots about a point at the center of the grating.

FIG. 5 is an isolated view like that of FIG. 3 showing a movable output reflector used to redirect the narrowband optical output from an output Bragg grating that pivots about a point offset from a center of the grating.

FIG. 6 is a schematic view of an output portion of an optical signal generator which uses multiple Bragg gratings mounted to a rotation table.

### DETAILED DESCRIPTION

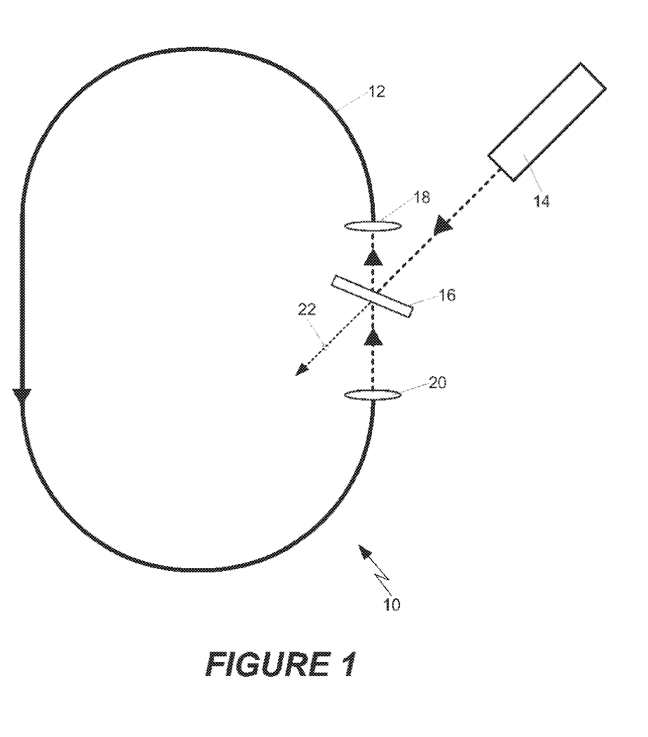

Shown in FIG. 1 is a broadband light accumulator 10 according to the present invention. The apparatus 10 makes use of a section of microstructured optical fiber 12, such as that produced by NKT Photonics A/S, Birkerød, Denmark. Coupled into this fiber is the output from a pump laser 14, which has an output wavelength of λₚ. The laser output is directed to a first volume Bragg grating 16 that is tuned to the wavelength λₚ. The output of the laser is therefore almost entirely reflected by the grating 16, and the reflected portion is coupled into the fiber 12 by lens 18.

The optical signal coupled into microstructured fiber 12 propagates through the fiber and undergoes a spectral broadening, as is known in the art. That is, the fiber 12 functions as a supercontinuum cavity, distributing the optical energy across a wide wavelength band. Those skilled in the art will understand that, while shown as a single loop in the schematic view of FIG. 1, and fiber 12 may be quite long and may be arranged in a coil. The light exiting the fiber 12 is collimated by collimating optics 20, which could be, for example, an achromatic lens or an off-axis parabola, and directed toward the Bragg grating 16. Since the grating 16 is tuned to wavelength λₚ, optical energy at λₚ (shown at 22) is rejected by the grating and is lost. However, the energy in the remaining wavelengths passes through the grating 16 and is coupled back into the fiber along with the pump laser energy via focusing optics 18, which is similar to optical element 20. The depleted λₚ band in the fiber is filled by the pump laser energy, as well as by the reinjected broadband energy, both of which are redistributed across a broad wavelength band due to interaction with the microstructured fiber. As the pumping of the fiber continues, the power density in the fiber increases until the losses equal the pump power. That is, the intensity of the broadband light in the fiber reaches a maximum when the power of the non-converted light at λₚ rejected by the grating 16, plus typical system losses such as injection loss and absorption in the fiber, equals the input power from the pump laser. At this point, the system has reached a steady state.

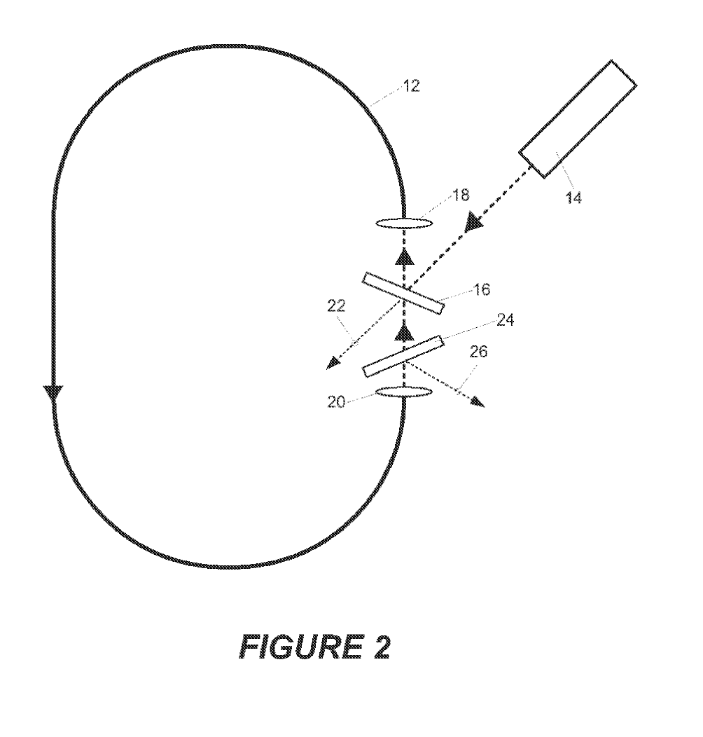

The arrangement of FIG. 1 provides a highly efficient broadband light accumulator, and may be used to create a tunable light source, as shown in FIG. 2. In this configuration, a second volume Bragg grating 24 is located between the output lens 20 and the Bragg grating 16. The grating 24 is tuned to an output wavelength λₒ that is different than pump wavelength λₚ. The broadband light exiting the lens 20 passes through the grating 24 except for light at the grating wavelength λₒ, which is redirected as shown at 26. As with the FIG. 1 configuration, a steady state will be reached in the system of FIG. 2 when the optical energy output from the system equals that being injected into it. That is, there will be a steady state condition when the power in the residual beam output 22 at wavelength λₚ plus the power in the output beam 26 at λₒ (plus any system losses) equal the pump laser 14 input power.

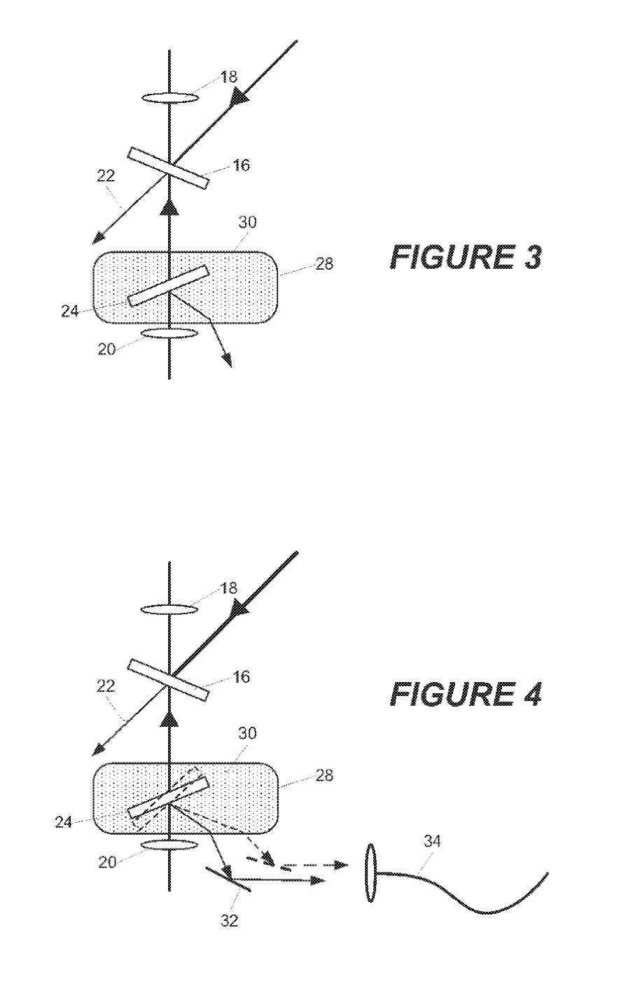

While the output 26 of the FIG. 2 embodiment is referred to as λₒ, the actual output wavelength may be changed dynamically by changing the angle of the Bragg grating 24. This changes the direction of the output wavelength selected and redirected by the grating, and will also result in a lateral shift due to refraction of the broadband beam passing through the grating 24 if there is a difference in the index of refraction between the grating surface and the surrounding environment (e.g., air). To avoid this refraction, an index matching liquid may be provided that surrounds the grating 24 and eliminates this refractive index change. FIG. 3 is an isolated view of the system of FIG. 2 without the fiber 12. In this embodiment, a housing 28 is used that contains an appropriate index matching liquid 30. The housing has perpendicular surfaces relative to the direction of the broadband beam so that it does not change the beam direction. Moreover, since the index matching liquid 30 has an index of refraction matched to that of the grating, there is no refraction of the broadband beam portion passing through the grating 24, and changing the angle of the grating does not affect the beam direction.

It is important that the space within the housing 28 is sufficiently large to permit all of the desired angles for the grating 24 within. This is demonstrated in FIG. 4, which shows the grating 24 in different possible orientations that permit the extraction of different desired wavelengths. Since changing the wavelength selection by changing the angle of the grating 24 also changes the direction of the output beam, the system must be capable of receiving the different beam directions. In the embodiment of FIG. 4, a moving mirror 32 is used to redirect the output beam into a collection fiber. The mirror 32 may be on a rotation table along with the Bragg grating 24 to allow the components to move between the different positions necessary to correctly redirect the output beam.

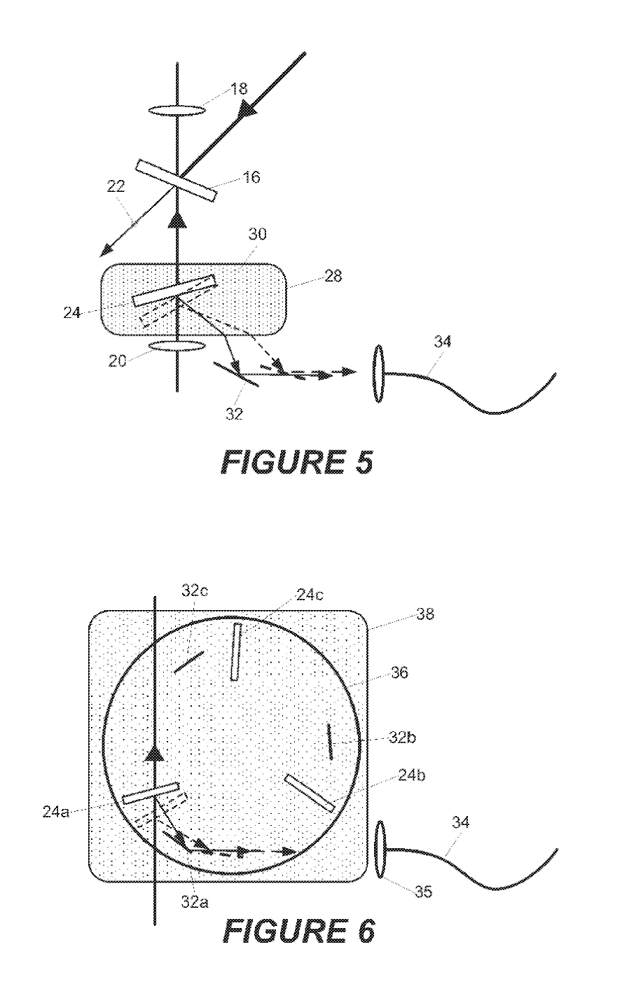

The FIG. 4 embodiment allows for proper positioning of the mirror 32 relative to the output beam, but results in the redirected beams being at different (albeit parallel) lateral positions, which would have to be taken into account with the receiving components. In a variation of this embodiment, a rotation table is used for which a center of rotation is located not at the center of the Bragg grating 24 but, rather, is offset relative thereto. As shown in FIG. 5, having the Bragg grating pivot point being offset relative to its center creates a situation where the redirected output beams may be reflected by the mirror 32 along the same line regardless of the grating angle. In this embodiment, the movement of the mirror will not be along a straight line, but it will allow the wavelength of the output beam to be tuned without having to reposition the receiving optics. Using a rotation table with a pivot point offset relative to the center of the Bragg grating 24 also allows the possibility of using different Bragg gratings on the rotation table, as is discussed in more detail below.

Shown in FIG. 6 is a schematic view of a tunable laser source that makes use of multiple Bragg gratings (24a, 24b, 24c), each located at a different position on a rotation table 36. As in the embodiment of FIG. 5, the relative pivot point for each grating is offset from its center, and a mirror (32a, 32b, 32c) is associated with each orating and located on the rotation table 36 such that its movement allows the reflection of the beam for a wide range of different grating angles when the table is rotated. With an appropriate positioning of the mirror relative to the grating and the point of rotation for the rotation table 36, the light reflected from each grating 24 follows the same path to collection lens 33 for each of a continuous range of different mirror positions. In addition, as in the embodiments of FIGS. 3-5, the gratings 24a, 24b, 24c are each located in a housing filled with index matching fluid. Light reflected by the mirrors 32a, 32b, 32c passes through a low-reflection, perpendicular surface of the housing 38 en route to the collection lens 35 and fiber 34.

The use of multiple pivoting gratings allows the system to be tunable over a much larger range than if just a single grating were used. For example, each grating might be tunable over a range of 200 nm, providing an overall tunable range of 600 nm, e.g., from 400 nm to 1000 nm. This is just an example of the possible wavelength output of the tunable source, and those skilled in the art recognize that the actual output range may be selected for a specific application. In addition, it will be understood that this is just one example of how multiple gratings may be used with the system. Other arrangements, some of which may use more than three gratings, are also anticipated.

1. A broadband optical accumulator comprising:
an optical fiber apparatus having a microstructured optical fiber configured such that an optical signal present in the fiber propagates repeatedly therewithin;
a narrowband optical source that generates optical energy in a first narrow wavelength band; and
an injection apparatus that couples the first narrow wavelength band optical energy into a first end of the fiber, said narrowband optical energy undergoing spectral broadening as it propagates within the fiber cavity.

2. A broadband optical accumulator according to claim 1 wherein optical energy coupled into the first end of the fiber exits a second end of the fiber, and wherein the optical fiber apparatus is configured such that optical energy exiting the second end of the fiber is coupled back into the first end of the fiber.

3. A broadband optical generator according to claim 1 wherein the injection apparatus comprises a wavelength dependent element located in an optical path of the optical energy exiting the second end of the fiber, the wavelength dependent element redirecting the optical energy from the optical source toward the first end of the optical fiber such that it is coupled into the first end of the fiber together with optical energy exiting the second end of the fiber.

4. A broadband optical generator according to claim 3 wherein the wavelength dependent element comprises a volume Bragg grating.

5. An optical signal generator comprising:
a microstructured optical fiber;
a narrowband optical source that couples optical energy in a first narrow wavelength band into a first end of the fiber, said narrowband optical energy undergoing spectral broadening as it propagates in the fiber such that an output signal exiting a second end of the fiber has a broadened spectral characteristic; and
a wavelength separator that receives the output signal as it exits the fiber and redirects a predetermined narrowband portion of the output signal to an output location, while enabling coupling of a remainder of the output signal back into the fiber, the wavelength separator having a center filter wavelength that is significantly different from a center wavelength of said first narrow wavelength band.

6. An optical signal generator according to claim 5 wherein the wavelength separator comprises a volume Bragg grating.

7. An optical signal generator according to claim 6 wherein an angle at which the output signal is incident on the grating may be adjusted to adjust said center filter wavelength.

8. An optical signal generator according to claim 6 wherein the grating is pivotable about a point substantially at a center of the grating.

9. An optical signal generator according to claim 6 wherein the grating is pivotable about a point significantly offset from a center of the grating.

10. An optical signal generator according to claim 6 further comprising a rotation table upon which the grating is located.

11. An optical signal generator according to claim 10 further comprising an optical output component that receives said predetermined narrowband portion from the grating, said output component being located on the rotation table such that, when the table is rotated, said output component moves relative to the grating so as to receive said predetermined narrowband portion for each of a plurality of different grating positions.

12. An optical signal generator according to claim 7 wherein the grating is surrounded by a refractive index matching material that minimizes refraction of said remainder of the output signal.

13. An optical signal generator according to claim 12 further comprising a housing within which the refractive index matching material is contained.

14. A method of generating a broadband optical signal comprising:
providing a microstructured optical fiber configured such that an optical signal coupled into a cavity of the fiber propagates repeatedly therein;
generating optical energy in a first narrow wavelength band with a narrowband optical source; and
coupling said narrowband optical energy into a first end of the fiber with an injection apparatus, said narrowband optical energy undergoing spectral broadening as it propagates within the fiber cavity.

15. A method according to claim 14 wherein optical energy coupled into the first end of the fiber exits a second end of the fiber, and wherein the optical fiber apparatus is configured such that optical energy exiting the second end of the fiber is coupled back into the first end of the fiber.

16. A method according to claim 14 wherein the injection apparatus comprises a wavelength dependent element located in an optical path of the optical energy exiting the second end of the fiber, the wavelength dependent element redirecting the optical energy from the optical source toward the first end of the optical fiber such that it is coupled into the first end of the fiber together with optical energy exiting the second end of the fiber.

17. A method according to claim 16 wherein the wavelength dependent element comprises a Bragg grating.

18. A method of generating an optical signal comprising:
providing a microstructured optical fiber;
coupling optical energy in a first narrow wavelength band into a first end of the fiber with a narrowband optical source, said narrowband optical energy undergoing spectral broadening as it propagates in the fiber such that an output signal exiting a second end of the fiber has a broadened spectral characteristic; and
receiving the output signal as it exits the fiber with a wavelength separator that redirects a predetermined narrowband portion of the output signal to an output location, while enabling coupling of a remainder of the output signal back into the fiber, the wavelength separator having a center filter wavelength that is significantly different from a center wavelength of said first narrow wavelength band.

19. A method according to claim 18 wherein the wavelength separator comprises a Bragg grating.

20. A method according to claim 19 further comprising adjusting an angle at which the output signal is incident on the grating to adjust said center filter wavelength.

21. A method according to claim 20 wherein adjusting the angle at which the output signal is incident on the grating comprises pivoting the grating about a point substantially at a center of the grating.

22. A method according to claim 20 wherein adjusting the angle at which the output signal is incident on the grating comprises pivoting the grating about a point significantly offset from a center of the grating.

23. A method according to claim 19 further comprising locating the grating on a rotation table.

24. A method according to claim 23 further comprising receiving said predetermined narrowband portion from the grating with an optical output component located on the rotation table such that, when the table is rotated, said output component moves relative to the grating so as to receive said predetermined narrowband portion for each of a plurality of different grating positions.

25. A method according to claim 19 further comprising surrounding the grating by a refractive index matching material that minimizes refraction of said remainder of the output signal.

26. A method according to claim 25 further comprising locating the grating and the index matching material in a housing.
